(19) United States
(12) Patent Application Publication
(10) Pub. No.: US 2020/0074395 A1
(43) Pub. Date: Mar. 5, 2020

(54) COMMUNICATION AND CONTROL ARCHITECTURE OF INTERNET-OF-THINGS EQUIPPED FREIGHT TRAIN

(71) Applicant: Steven Goldmann, Hastings, MN (US)

(72) Inventor: Steven Goldmann, Hastings, MN (US)

(21) Appl. No.: 16/557,927

(22) Filed: Aug. 30, 2019

Related U.S. Application Data
(60) Provisional application No. 62/725,093, filed on Aug. 30, 2018.

(51) Int. Cl. G06Q 10/08; H04L 29/08; F25D 11/00

(52) U.S. Cl. CPC G06Q 10/0832; G06Q 10/0833; F25D 11/003; H04L 67/12; G06Q 10/087

(57) ABSTRACT

A freight car includes an internet-of-things (IOT) controller. The IOT controller includes a processor, and a machine readable memory storing instructions. The machine readable memory is accessible by the processor. A sensor being communicable to the IOT controller. The sensor senses a parameter of the fright car. The sensor sends data of the parameter to the IOT controller. The IOT controller is configured to recognize an actionable event from the data. The IOT controller activates an actuator if the actionable event is recognized.

### FIELD OF THE DISCLOSURE

The embodiments of this disclosure relates to internet-of-things (IOT) equipped freight train. More specifically, the embodiments of this disclosure relates to the communication and control architecture of one or more freight trains that are equipped with various sensors communicable with an IOT controller.

### BACKGROUND

Fresh meat and produces can spoil within hours if not property refrigerated. Thus, transportation of fresh meat and produces is a delicate task. Freight train is one of the major way to transport large amounts of goods because of its economic nature. However, freight train is not commonly used to transport fresh meat and produces, because its speed is slower and keeping the fresh meat and produces under proper conditions, e.g., temperature, moisture, etc, is challenging.

### SUMMARY

The embodiments of this disclosure relates to internet-of-things (IOT) equipped freight train. More specifically, the embodiments of this disclosure relates to the communication and control architecture of one or more freight trains that are equipped with various sensors communicable with an IOT controller.

In one embodiment, the freight train includes temperature sensor, moisture sensor, and light sensor. The IOT controller receives the signals from the temperature sensor, moisture sensor, and light sensor and controls the corresponding actuators to correct the temperature, the moisture, and or the light within the freight car. In one embodiment, the actuator for controlling the temperature is air conditioning unit. In one embodiment, the actuator for controlling moisture is humidifier/dehumidifier. In yet another embodiment, the actuator for controlling light is door shutter, winder shutter, or light bulbs.

In another embodiment, the freight train includes various gas sensors, e.g., oxygen sensor, ethyl acetate, ammonia sensor, or the like. These gas sensors are able to detect spoilage of meat or produces.

In yet another embodiment, the IOT controller includes GPS geolocation functionalities.

In one embodiment, various sensors and actuators are communicable with an IOT controller. The communication can be wired or wireless. The IOT controller is communicable with cell phone towers or satellites. The IOT controller can be communicable with one or more other IOT controllers.

In one embodiment, the IOT controller sends the recorded parameter, e.g., temperature, moisture, light, oxygen level, ammonia level, ethyl acetate level, or the like to a server. One or more end user device can connect to the server and view the recorded parameter on the user device in a user graphical interface.

In one embodiment, a freight car includes an internet-of-things (IOT) controller. The IOT controller includes a processor, and a machine readable memory storing instructions. The machine readable memory is accessible by the processor. A sensor being communicable to the IOT controller. The sensor senses a parameter of the fright car. The sensor sends data of the parameter to the IOT controller. The IOT controller is configured to recognize an actionable event from the data. The IOT controller activates an actuator if the actionable event is recognized.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 illustrates a communication architecture of one or more freight trains equipped with IOT controller according to one embodiment of the disclosure.

FIG. 2 shows an example freight car equipped with IOT controller according to one embodiment of the disclosure.

FIG. 3 shows an example freight car equipped with IOT controller according to one embodiment of the disclosure.

FIG. 4 shows an example freight car equipped with IOT controller according to one embodiment of the disclosure.

FIG. 5 shows an example graphical user interface (GUI) according to one embodiment of the disclosure.

FIG. 6 illustrates a IOT controller for obtaining access to database files in a computing system according to one embodiment of the disclosure.

FIG. 7 illustrates a computer system adapted according to certain embodiments of the processor and/or the user interface device.

### DETAILED DESCRIPTION

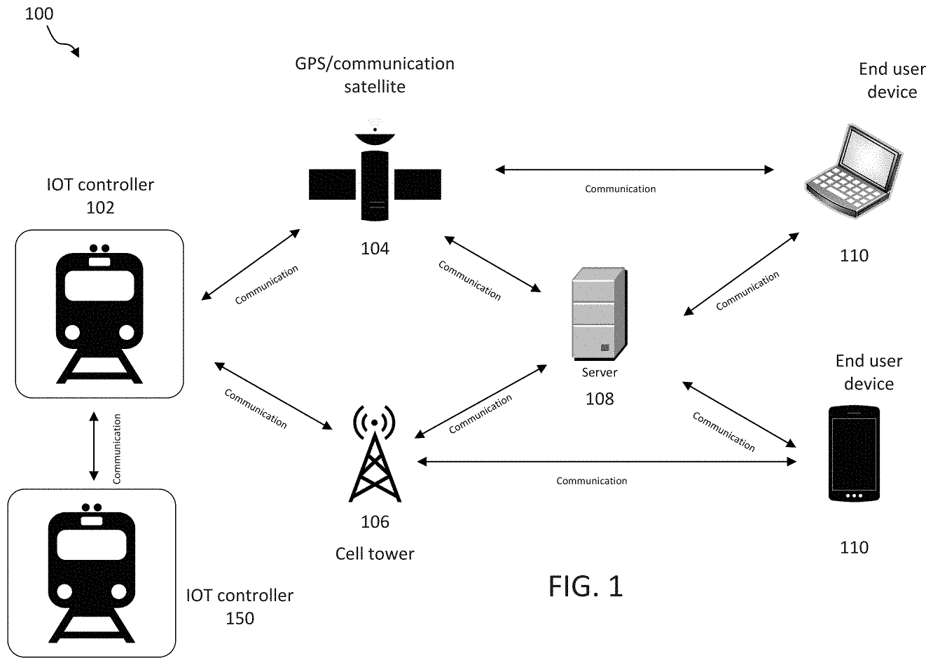

FIG. 1 illustrates a communication architecture 100 of one or more freight trains equipped with IOT controller according to one embodiment of the disclosure. The communication architecture 100 includes an IOT controller 102. The IOT controller 102 is communicable with another IOT controller 150, a GPS/communication satellite 104, or a cell tower 106.

The IOT controllers 102, 150 can be either installed on a freight car or a locomotive engine of a train. In one embodiment, the IOT controller 102 is installed on a freight car that stores the fresh meat and produces, and the IOT controller 150 is installed on the locomotive engine. In another embodiment, both IOT controllers 102 and 150 are installed on a same or different freight cars.

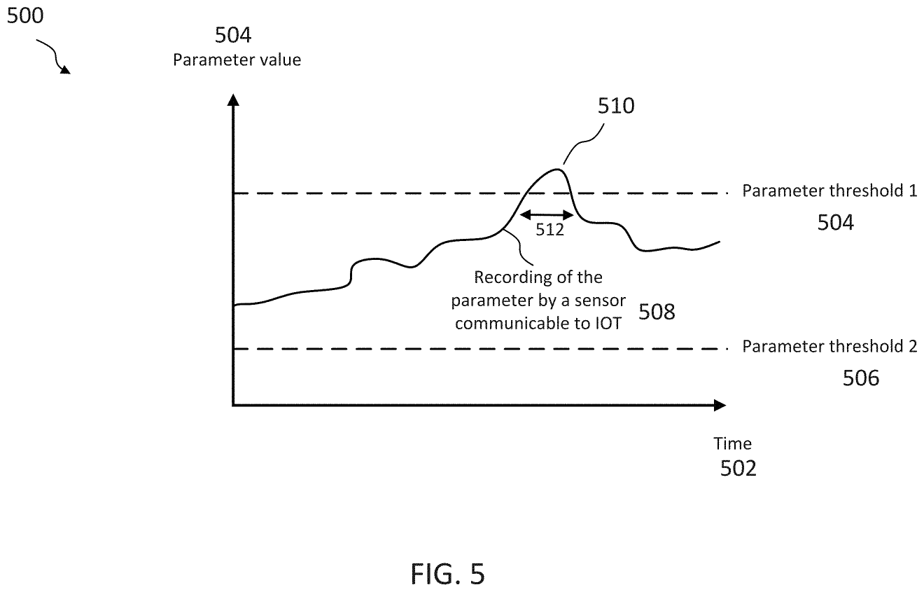

In one embodiment, the IOT controller 102 is installed on a freight car. The IOT controller 102 may receive various signals sent by various sensors, e.g., temperature, moisture, light, oxygen, ethyl acetate, ammonia, etc. The IOT may send the data to the server 108 through the satellite 104 and/or the cell tower 106. The end user devices 110 and 112 can access the data collected by the IOT Controller 202s through the server 108. The graphical interface as shown in FIG. 5 can be shown on the end user devices 110. The end user device 110 can be a desk top computer, a laptop computer, a cell phone, a tablet, or the like.

The end user device 110 can be a shipping service provider. The end user device 110 can be an intended receiver of the shipped goods. The end user device 110 can also be a shipper of the goods. The end user device 110 can also be a freight train operating personnel.

In yet another embodiment, the IOT controller 102, 150 can communicate to end user devices 110 directly through the GPS/communication satellite 104 and/or the cell tower 106, without going through the server. This direct communication may be used under special circumstances, for example, when the temperature of an interior space of a freight car is over a threshold temperature over a threshold time period, then the IOT controller 102, 150 may send an alert message to the end user device 110 directly.

For example, if the freight car is transporting fresh meat that is supposed to be stored under −5 degree Celsius at all time. The IOT 102 may send a real time alert to the end user device, not going through the server 108, if an interior temperature of the freight car is higher than −5 degree Celsius (threshold temperature) for over ten minutes (threshold time period).

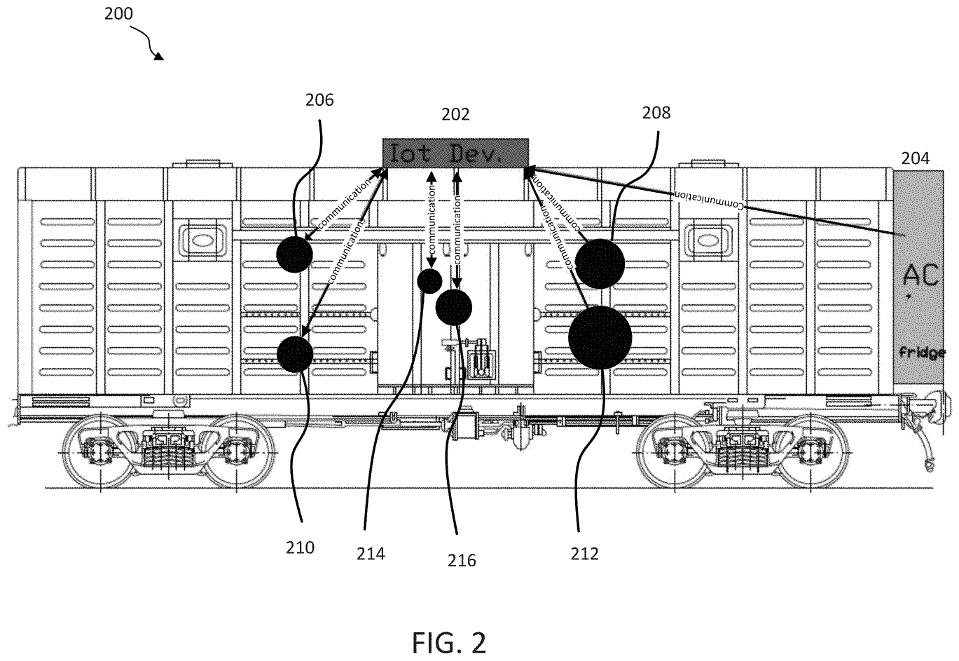

FIG. 2 shows an example freight car 200 equipped with IOT controller 202 according to one embodiment of the disclosure. The IOT controller 202 is communicable with various sensors, e.g., temperature sensor 206, moisture sensor 210, light sensor 214, door sensor 216, gas sensor 212, geolocation sensor 208, or the like. The deposition of the various sensors 206, 208, 210, 212, 214, and 216 can be strategically place anywhere on the freight car, not limited to the positions shown in FIG. 2. FIG. 2 is merely an example.

In one embodiment, the freight car 200 has multiple compartments, wherein each compartment has a designated target temperature. In this case, each compartment may have a corresponding IOT controller 202 and one or more corresponding sensors 206, 208, 210, 212, 214, and 216.

The temperature sensor 206 continuously monitors a temperature of an interior space of the freight car 200. The temperature sensor 206 sends the temperature data, which is a parameter for the purpose of this disclosure, to the IOT controller 202. The IOT controller 202 then communicate the data as shown in FIG. 1. The temperature monitored by the temperature sensor 206 can be the recorded parameter 508 as shown in FIG. 5.

The moisture sensor 210 continuously monitors a humidity level of an interior space of the freight car 200. The moisture sensor 210 sends the humidity data, which is a parameter for the purpose of this disclosure, to the IOT controller 202. The IOT controller 202 communicates the data as shown in FIG. 1. The humidity level monitored by the moisture sensor 210 can be the recorded parameter 508 as shown in FIG. 5.

The light sensor 214 continuously monitors a light intensity level of an interior space of the freight car 200. The light sensor 214 sends the light intensity data, which is a parameter for the purpose of this disclosure, to the IOT controller 202. The IOT controller 202 communicates the data as shown in FIG. 1. The light intensity monitored by the light sensor 214 can be the recorded parameter 508 as shown in FIG. 5. In some situations, the door of the freight car 200 should not be opened from the place of origination to the destination. The light sensor 214 is useful to monitor whether the doors of the freight car is opened. Thus, in one embodiment, the light sensor 214 is installed behind the door. In one embodiment, the light sensor 214 is actually a camera, that may take pictures or videos of the interior space of the freight car.

The door sensor 216 may monitor whether the door lock of the freight car 200 is opened. In some situations, the door of the freight car 200 should not be opened from the place of origination to the destination. The IOT can be set as, once the door of the freight car 200 is opened, the IOT sends an alert message to an end user device 110.

In one embodiment, the freight car 200 may include a door sensor 216 and a door open/locking apparatus. The door sensor 216 senses whether the door of the freight car is in an open or closed state. If the door is opened during the shipping process, the IoT controller 202 device will log the door-opening event and may send an alert accordingly. The IoT controller 202 may also instruct a camera (the light sensor 214), or cameras, to start recording video, if the door is open or opened unexpectedly. In another embodiment, the IOT controller 202 may lock the door, or keep the door locked, preventing any unauthorized access to the freight car.

The gas sensor 212 continuously monitors a gas concentration of an interior space of the freight car 200. The gas sensor 212 sends the gas concentration data, which is a parameter for the purpose of this disclosure, to the IOT controller 202. The IOT controller 202 communicates the data as shown in FIG. 1. The gas concentration monitored by the gas sensor 212 can be the recorded parameter 508 as shown in FIG. 5. The gas sensor 212 can sense oxygen, carbon dioxide, nitrogen, ethyl acetate, ammonia, and/or the like.

In one embodiment, the interior space of the freight car is filled with nitrogen, thus, the oxygen level and carbon dioxide lever ought to stay under a threshold lever, unless there is an air leak. In such case, the gas sensor 212 that senses oxygen can be used to detect air leak.

The geolocation sensor 208 can be a GPS sensor that monitors a travel route of the freight car 200. This information is useful for the shipper and receiver to have an accurate time of arrival. The GPS signal and/or time of arrival can also be used to predict whether the power and/or supplies of the equipment for sustaining a particular condition (temperature, humidity, gas level, etc.) of the freight car 200 is sufficient. For example, if the interior space of the freight car 200 is equipped with a liquid nitrogen gas tank that keeps filling the storage cabin of the freight car 200 with nitrogen, the estimated time of arrival based on the GPS signal provided by the geolocation sensor 208 and the nitrogen level provided by the gas sensor 212 can be used to determine whether the nitrogen gas tank needs to be replaced before arrival.

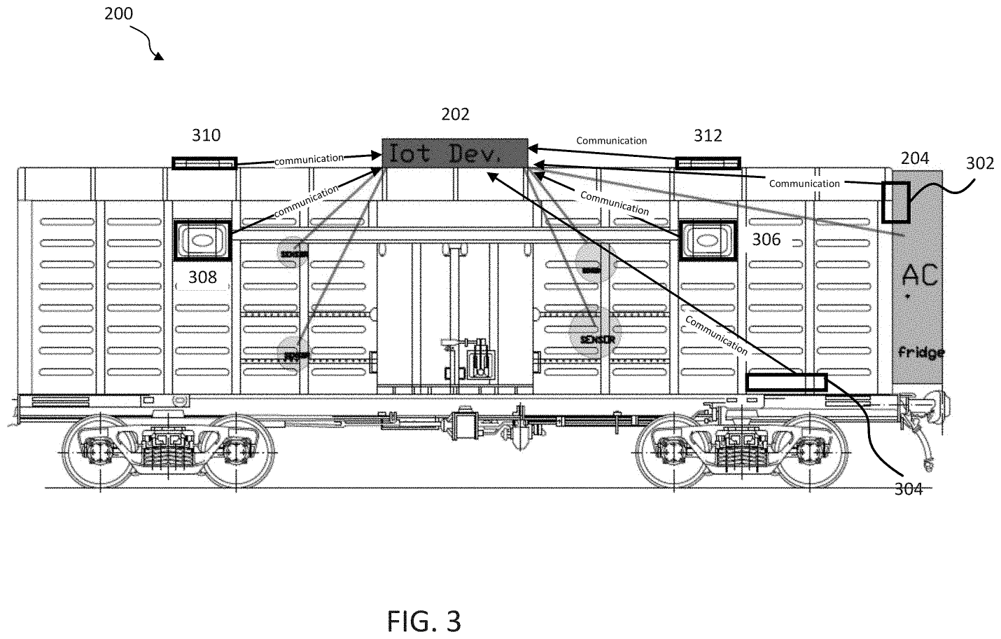

FIG. 3 shows an example freight car 200 equipped with IOT controller 202 according to one embodiment of the disclosure.

In one embodiment, the IOT controller 202 may receive various operating signals from the refrigeration unit. For example, various parameters of the compressor of the air conditioning (AC) unit 204, including the power consumption, the rotating speed, the on/off state, the temperature, the heat-exchange efficiency, the air pressure, the working fluid (coolant) pressure and all other related data available.

For example, in one embodiment, the IOT controller 202 may sense the compressor of the AC unit has been working under a threshold rotation speed (e.g., 5000 rpm) over a threshold time period (e.g., 30 minutes). Such working condition of the compressor may trigger an alert according to a control policy of the IOT controller 202, the IOT controller 202 may reduce the rotation speed of the compressor, shut it off completely or make other applicable adjustments. The control policy may specify various rules for controlling the AC, for the purposes of protecting the payloads in the freight car, to conserve energy, as well as to protect the refrigeration unit itself.

As shown in FIG. 3, the freight car may include a plurality of fans 302, 340, 306, 308, 310, 312 that facilitate the circulation of air within the freight car. The IoT controller 202 may control the fans 306, 308, 310, 312 according to various parameters, including the local temperatures sensed by each sensor.

In one embodiment, the freight car 200 has a first fan 304, a floor fan. The fan 304 can circulate the air near the ground to the top. The freight car 200 has a second fan 310 at a top roof of the freight car 200. The freight car 200 as a first sensor disposed near a floor, a second sensor disposed near a top of the storage cabin of the freight car 200. When the temperature near the top of the storage cabin is too high, the IOT controller 202 activates the first fan 304 to bring the colder air near the floor to the top. The IOT controller 202 may also activate the second fan 312 to blow the hot air out of the storage cabin.

The IOT Controller 202 may also control the fans 302 in the refrigeration unit to increase or decrease the intake/output of air flow of the AC unit according to various control algorithms within the IOT Controller 202.

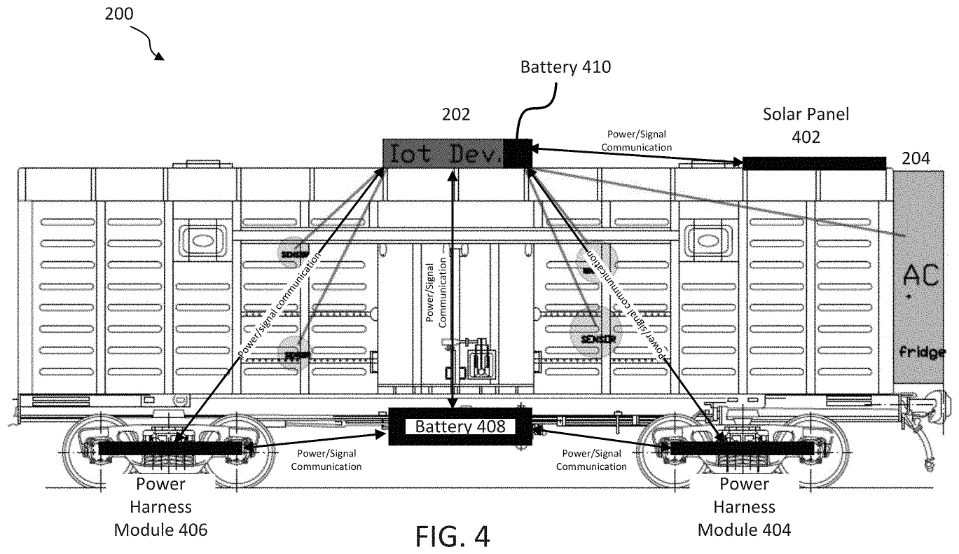

FIG. 4 shows an example freight car 200 equipped with IOT controller 202 according to one embodiment of the disclosure.

The freight car 200 may include one or more solar panels 402 on top or on the side(s) of the freight car. The freight car 200 may further include one or more chargeable batteries 408, 410. In one embodiment, the chargeable battery 408, 410, or batteries, may be disposed inside or outside of the freight car. In other embodiment, the chargeable battery 408, 410, or batteries, can be disposed on top of, near the bottom of, or under the freight car. In one embodiment, the chargeable battery 408, 410, or batteries, may be charged by the solar panel(s).

In another embodiment, the chargeable batteries 408, 410, may be charged by the power harness modules 404, 406 which convert the motion to electric power. In one example, the power harness modules 404, 406 includes coils and/or magnets. The power harness module 404, 406 may harness the motion power when the freight car is reducing its speed, e.g., breaking. In one example, the power harness module 404, 406 are disposed at one or more of the wheels of the freight car.

In another embodiment, there are motion sensors (not shown) disposed at one or more of the wheels of the freight car. The sensors may sense the speed or rotation of the wheels. Using such signals, the IOT controller 202 may calculate the overall speed, travelled mileages, accelerations, collisions, etc of the freight car.

In one embodiment, the IOT controller 202 may determine whether the freight car 200 is accelerating or decelerating in speed. The IOT may instruct the power harness module 406, 404 to charge the battery 408, 410 only during periods of decreasing speed and not when increasing speed. The intent is to also not to allow harnessing power when the freight car 200 traversing a grade, etc.

The above disclosures are only examples of the invention and should not be understood to limit the scope of the invention in any way. Additional methods of applying the sensor signals for various control algorithms later disclosed shall be considered supported by this disclosure.

FIG. 5 shows an example graphical user interface (GUI) according to one embodiment of the disclosure. The IOT controller 202 provides various recordings of parameters 508 to an end user device 110 using the communication architecture 100 as shown in FIG. 1.

The recorded parameter 508 can be provided by any of the sensors suitable for the purpose, e.g., temperature sensor 206, moisture sensor 210, light sensor 214, door sensor 216, gas sensor 212, geolocation sensor 208, a pressure sensor of a gas tank (nitrogen, carbon dioxide, etc.), a power level of a battery, a speed of the freight car, an acceleration/deceleration of the freight car, an ambient pressure (e.g., measured by barometer) inside and/or outside of the freight car, or the like.

The recorded parameter 508 can include various parameters of the compressor of the air conditioning (AC) unit 204, including the power consumption, the rotating speed, the on/off state, the temperature, the heat-exchange efficiency, the air pressure, the working fluid (coolant) pressure and all other related data available.

The graphical user interface (GUI) 500 can be displayed on a monitor of the end user device. The GUI 500 includes an x-axis 502 that can be time and a y-axis 504 that can be the parameter value. The GUI 500 includes a drawing of the recording of the parameter by a sensor communicable to the IOT controller 508.

The GUI 500 also includes a first threshold 504 for the parameter 508. The first threshold 504 can be a maximum threshold for the parameter. The GUI 500 includes a second threshold 506 for the parameter 508. The second threshold 506 can be a minimum threshold for the parameter 508. The GUI 500 may also include a time period threshold 512. The IOT controller can recognize an actionable event 510.

In one embodiment, the freight car 200 is transporting fresh fruits. The parameter 508 can be temperature. The first threshold 504 is six (6) Celsius degree. The second threshold 506 is zero (0) Celsius degree. The time threshold is ten (10) minutes. If the parameter 508 if over the first threshold 504 for more than the time period threshold 512, the IOT controller 202 can take actions. The actions can be any suitable actions, e.g., increasing the rotation speed of the AC compressor, send alert to the shipper/receiver/shipper servicer, activating a certain fan, etc.

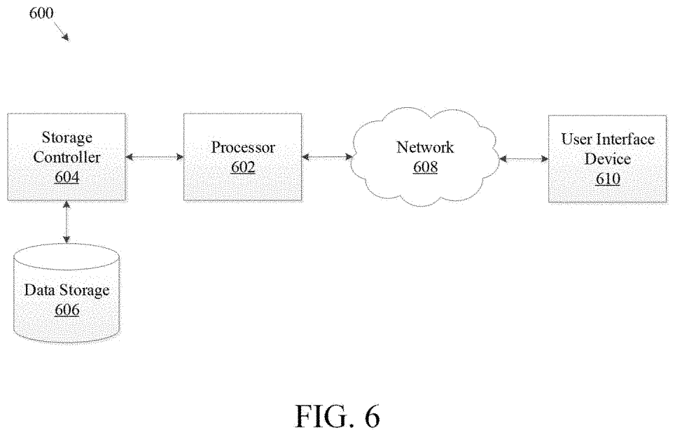

FIG. 6 illustrates an IOT controller 600 for obtaining access to data in a computing system according to one embodiment of the disclosure.

The IOT controller 600 may include a processor 602, a data storage device 606, a network 608, and a user interface device 610. The processor 602 may execute a hypervisor-based system executing one or more guest partitions hosting operating systems with modules having server configuration information. In a further embodiment, the IOT controller 600 may include a storage controller 604, or a storage server configured to manage data communications between the data storage device 606 and the processor 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other mobile communication device having access to the network 608. In a further embodiment, the user interface device 610 may access the Internet or other wide area or local area network to access a web application or web service hosted by a server having the processor 602 and may provide a user interface for enabling a user to enter or receive information.

The network 608 may facilitate communications of data between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

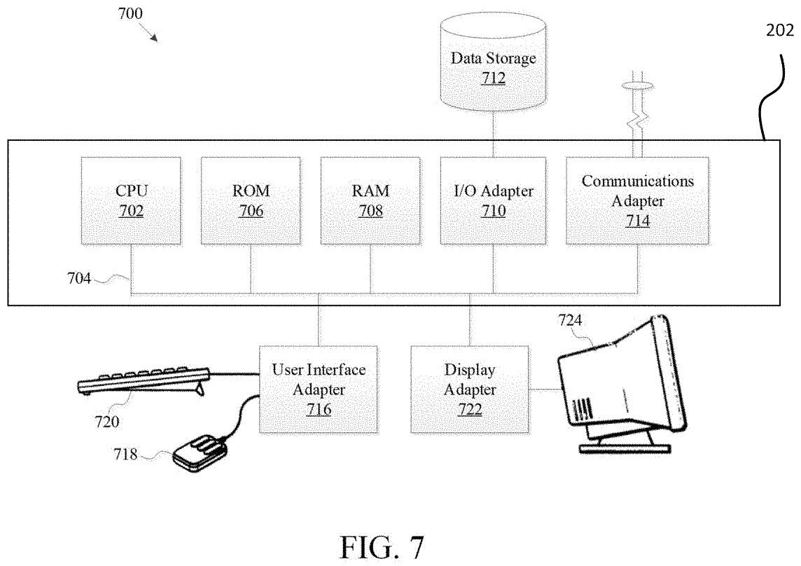

FIG. 7 illustrates a IOT communication system 700 adapted according to certain embodiments of the processor 602 and/or the user interface device 610. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The IOT communication system 700 includes an IOT controller 202. The IOT controller 202 may also include random access memory (RAM) 708, which may be synchronous RAM (SRAM), dynamic RAM (DRAM), synchronous dynamic RAM (SDRAM), or the like. The IOT controller 202 may utilize RAM 708 to store the various data structures used by a software application. The IOT controller 202 may also include read only memory (ROM) 706 which may be PROM, EPROM, EEPROM, optical storage, or the like. The ROM may store configuration information for booting the IOT controller 202. The RAM 708 and the ROM 706 hold user and system data, and both the RAM 708 and the ROM 706 may be randomly accessed.

The IOT controller 202 may also include an I/O adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the IOT controller 202. According to one embodiment, the data storage 712 may be a separate server coupled to the IOT controller 202 through a network connection to the I/O adapter 710. The communications adapter 714 may be adapted to couple the IOT controller 202 to the network 708, which may be one or more of a LAN, WAN, and/or the Internet. The user interface adapter 716 couples user input devices, such as a keyboard 720, a pointing device 718, and/or a touch screen (not shown) to the IOT controller 202. The display adapter 722 may be driven by the CPU 702 to control the display on the display device 724. Any of the devices 702-722 may be physical and/or logical.

If functionalities of the IOT controller being implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A freight car, comprising
an internet-of-things (IOT) controller, the IOT controller further including,
a processor, and
a machine readable memory storing instructions, the machine readable memory accessible by the processor,
a sensor, the sensor being communicable to the IOT controller, the sensor sensing a parameter of the fright car, the sensor sending data of the parameter to the IOT controller;
wherein the IOT controller is configured to recognize an actionable event from the data, the IOT controller activates an actuator if the actionable event is recognized.

2. The freight car according to claim 1, wherein the sensor is at least one selected from the following: temperature sensor, light sensor, gas sensor, speed sensor, barometer, pressure sensor, and a battery power sensor.

3. The freight car according to claim 2, wherein the parameter is at least one selected form the following: temperature, light intensity, gas concentration, speed, ambient pressure, gas or fluid pressure, and a battery power level.

4. The freight car according to claim 1, wherein the actuator is at least one selected from the following: an air conditioning unit, a humidifier, a dehumidifier, a gas tank, a solar panel, a freight car break, a battery, and a power harness module.

5. The freight car according to claim 1, including
a first threshold;
a time period threshold;
wherein if the parameter is larger than the first threshold longer than the time period threshold, the IOT controller recognizes the actionable event.

6. The freight car according to claim 1, including
a second threshold;
a time period threshold;
wherein if the parameter is lower than the second threshold longer than the time period threshold, the IOT controller recognizes the actionable event.

7. The freight car according to claim 1, wherein the IOT controller is communicable to a satellite or a cell tower.
